(19) United States
(12) Patent Application Publication
(10) Pub. No.: US 2009/0084244 A1
(43) Pub. Date: Apr. 2, 2009

(54) Guitar Pick

(76) Inventor: Bradley C. Goad, Salem, OR (US)

Correspondence Address: PETER A. HAAS, ESQUIRE, 1929 SW 13TH AVENUE, PORTLAND, OR, 97201, US

(21) Appl. No.: 12/333,218

(22) Filed: Dec. 11, 2008

Related U.S. Application Data
(63) Continuation-in-part of application No. 11/668,075, filed on Jan. 29, 2007.

(51) Int. Cl. G10D 3/16

(52) U.S. Cl. 84/320

(57) ABSTRACT

The present invention contemplates a pick for a stringed instrument, the pick comprises a main pick body having a plurality of linearly aligned strike heads; and a gripping means coupled to the main pick body. The gripping means further includes attaching means adapted to couple to a front surface of the main pick body to enable about 360-degrees of rotation of the gripping means about an axis generally perpendicular to the front surface. And, the gripping means further comprises a generally curvilinear clip structure configured to enable a musician to place a finger or thumb there-through to enhance grip of the main pick body and to facilitate stroking the stringed instrument.

### PRIORITY CLAIM

The present is a continuation-in-part application and claims benefit under 35 USC Section 119(e) of U.S. Non-provisional Patent Application Ser. No. 11/668,075 filed on 29 Jan. 2007. The present application is based on and claims priority from these applications and shares a common inventor and the disclosure is hereby expressly incorporated herein by reference.

### BACKGROUND

The present invention relates to a plectrum and specifically to an improvement to traditional guitar picks.

This document refers to a “pick” or a “guitar pick” interchangeably and it will be understood by those skilled in the art that such a device may specifically be used to strum guitar strings; but it could be utilized on any type of stringed instrument and, therefore, should not be construed as limiting. A pick—a type of plectrum—as generally known in the prior art, takes the shape of an acute isosceles triangle with two generally equally rounded corners and a third more acutely rounded corner. Common shapes include the equilateral pick, the shark's fin pick and the sharp edged pick. FIGS. 2 and 3 show a common equilateral pick of the prior-art.

Traditional materials for picks include celluloid, nylon, plastic, tortex, delrex, lexan, rubber, felt, tortoiseshell, wood, metal, and stone. Picks may include a friction-increasing coating to enhance a musician's grip.

Generally, the most common range of individual thicknesses of picks varies from about 0.38 mm to about 1.50 mm and may have uniform thickness or a variable thickness. The playing style, preference, and desired sound affects determine which specific pick thickness a stringed-instrument artists selects.

Broadly stated and remaining within one type of material, thinner picks are more flexible and offer a wider range of sounds. Heavier weight, or thicker, picks produce a brighter tone, but are also associated with an undesirable “click” sound when the pick attacks the strings.

Generally, the genre of music may determine the desired pick thickness. For example, in rock and metal music, which uses hi-gain amplification or distortion, it is generally assumed that thinner picks produce muddier, heavier, less controllable sound and thicker picks produce more delicate, well shaped, and controlled tones. And, thinner picks are prone to tear, especially over time or if used forcefully.

The string gauge of the instrument may also affect a musician's decision in selecting a pick of a certain thickness. For example, Jazz guitar players tend to use thick picks because they also favor heavy gauge, flat-wound strings.

The traditional technique of using a pick includes gripping the opposing generally planar surface of the pick between the index finger and the thumb. However, the technique of holding a pick may vary greatly between musicians and, ultimately, is a personal preference issue. Some musicians use three fingers. More rare, is the use of two picks at once.

One improvement over a standard equilateral pick includes an integral band extending outward from each side of the main body and forming loop in a generally co-planar relationship to the main body and is described in U.S. Pat. No. 3,699,838 issued to Montgomery on 24 Oct. 1972. Elastic deformation of the loop due to inherent material properties of the pick enable a musician to wedge a finger or thumb between facing sides of the integral band and main pick body.

In another attempt to provide a more secure grip of the musician's finger to the pick, U.S. Pat. No. 3,789,720 issued to McIntyre on 05 Feb. 1974 describes a deformably resilient thimble having a spindle portion and trunion adapted to couple to a generally triangular pick having at receiving structure for the radially extending spindle member portion, thus enabling rotation of the pick about the trunion.

Improvements to the aforementioned and more traditional picks are also documented in the prior art. For example, U.S. Pat. No. 5,973,243 to Christenson issued on 26 Oct. 1999 discloses a pick device having finger loop. Other finger loops are described in U.S. Pat. No. 4,497,237 to Beall issued on 05 Feb. 1985, and U.S. Pat. No. 6,054,643 to Chance et al. issued on 25 Apr. 2000.

Despite these improvements to the basic pick, the finger-loop described in the prior art has significant limitations. For example, common to each reference, the finger-loop is rigidly mounted to the main pick body, which significantly limits the playing style of the individual musician because the pick has a very limited number of hold positions. Specifically and for example, the device described by Christenson slides over the end of a desired finger and can only be adjusted by rotating the strike head relative to the longitudinal axis of the selected finger.

And, the device disclosed by Chance et al. includes a clip on one side of an otherwise traditional pick, but there is insufficient space between the clip and the pick body to insert a finger and is otherwise mounted in fixed relation to the body, which significantly limits the hold position of the musician.

Yet, despite the variation in design and methods of use of the aforementioned picks representative of the prior-art, currently known picks severely limit advanced playing techniques. One such technique includes double striking a given string in a single pass. To accomplish a double strike in a single pass a musician must have two striking surfaces. This is facilitated by certain double-edged pick heads currently known such as the “Wicked Pick” and the “Double Pick” both available from http://www.stashpicks.com/productinfo.htm. And, FIGS. 16 through 22 show five typical pick designs known in the art, some of which have two or three strike heads. However, these designs have inherent limitations, which are further elaborated, below.

As an alternative to a single, integrated pick with multiple strike heads, accomplished musicians grip two individual and standard picks simultaneously and by trained skill, hold the two picks in a manner that enables double striking. However, as musicians reach forever more complicated picking techniques, existing picks fail to enable proper technique for triple, quadruple, and higher multiples of strikes on a single stroke. Yet, music fanatics, once hearing the multiple strikes on a single stroke, become so enamored with the effervescent resonance that they cannot help effuse elated adorations toward the musicians and signal their affection with spontaneous applause and donations of apparel that where quite recently and closely worn.

Thus, there remains a need for a novel pick design and method of use that readily enables even lesser skilled musicians to effect multiple strikes on a single stroke. Such a device should include multiple strike heads in a single pick and enable the musician to securely grip the device when playing a stringed instrument.

### SUMMARY OF THE INVENTION

To overcome the limitations of known picks, and to provide vastly improved playing techniques, the various embodiments of the present invention include combinations of features that enable a musician to securely grip the novel pick device in a myriad of hold positions and further enable the musician to effect multiple strikes on a given string in a single, one-directional stroke or bi-directional stroke of a stringed instrument.

Accordingly, in one embodiment the present invention includes a pick device having multiple strike heads in a single integrated body. In another embodiment, the present invention includes a gripping means rotatably and selectively coupled to a pick body.

Other advantages of various embodiments of the present invention include:

Enabling a musician to comfortably hold a pick with the confidence that they will not drop it;

Enabling a musician to attack two strings with one strike;

Enabling a musician to attack hit the strings 18 times in the down stroke and 24 times in the upstroke of a single strike;

Providing four different gauges of pick in a single pick;

Enabling a musician to attack three strings in one strike; and

Enabling a musician to attack three strings in one strike and also providing a single, separate strike head for the leads.

One preferred embodiment according to the present invention includes a pick device for a stringed instrument comprising: a main pick body having a front surface; and a gripping means coupled to the front surface to enable about 360-degrees of rotation of the gripping means about an axis generally perpendicular to the front surface.

Additionally, the gripping means further comprises a generally curvilinear clip structure configured to enable a musician to place a finger or thumb there-through to enhance grip of the main pick body and to facilitate stroking the stringed instrument.

And, the gripping means further comprises an attaching means adapted to selectively couple to the front surface.

The attaching means includes any one of the following: a brad, a snap-structure, or a rivet, or Velcro, or magnets; and the pick body further is adapted to couple to the attaching means.

The main pick body comprises a first resilient material and the gripping means comprises a second resilient material.

The main pick body further comprises nylon and includes a thickness comprising about 0.60 mm.

In a second preferred embodiment according to the present invention, a pick device comprises: a main pick body comprising a plurality of linearly aligned strike heads; and a gripping means coupled to the main pick body.

The pick device further includes a first strike head (of the plurality of linearly aligned strike heads), which includes a first thickness, and a second strike head includes a second thickness.

In a third preferred embodiment, a pick device comprises: a main pick body comprising four strike heads, each strike head arranged generally in a common plane and whereby at least one strike head is arranged about 90-degrees from a second strike head.

A fourth preferred embodiment includes a claw-style pick device for a stringed instrument, the pick device comprises: a first pick body comprising a first plurality of strike heads, the first pick body coupled to a gripping means; a second pick body coupled to an opposite end of the gripping means; and the gripping means being intermediately disposed between the first and second pick bodies.

This claw-style pick device further includes gripping means comprising a generally curvilinear clip structure configured to enable a musician to place a finger or thumb there-through to enhance grip of the main pick body and to facilitate stroking the stringed instrument.

And, the gripping means further comprises a first attaching means for coupling the first pick body to a first portion of the gripping means and a second attaching means for coupling the second pick body to a second portion of the gripping means.

Further, the claw-style pick device of claim includes the first attaching means, which adapts to couple to a first surface of the first pick body to enable about 360-degrees of rotation of the gripping means about an axis generally perpendicular to the first surface.

And, the claw-style pick device includes the first pick body comprising a first strike head coupled to a second strike head wherein the second strike head is disposed in relation to the first strike head to form a narrow V-shape when viewed from the side.

And, the second pick body comprises a first strike head, a second strike head, and a third strike head, each head disposed in a narrow V-shape in relation to each other head and wherein each head shares a common linking axis with each other head and wherein the linking axis couples to the gripping element.

In a fifth embodiment, a pick device for a stringed instrument comprises: a pick body comprising a plurality of strike heads; and a gripping means coupled to the pick body, the gripping means comprises a generally curvilinear clip structure configured to enable a musician to place a finger or thumb therethrough to enhance grip of the main pick body and to facilitate stroking the stringed instrument.

### DRAWING

FIG. 1 is a top view of yet another embodiment of a pick device according to the present invention.

FIG. 2 is a top view of a well-known triangular pick body as defined in the prior-art.

FIG. 3 is a side view of the prior-art pick body of FIG. 2.

FIG. 4 is a side view of a possible gripping means according to one embodiment of the present invention.

FIG. 5 is a top view of the gripping means of FIG. 4.

FIG. 6 is a bottom view of another embodiment of a pick device according to the present invention.

FIG. 7 is a top view of the pick of FIG. 6.

FIG. 8 is a top view of a further embodiment of a pick device according to the present invention.

FIG. 9 is a bottom view of the pick device of FIG. 8.

FIG. 10 is a top view of an in-line, dual strike head pick design of the prior art.

FIG. 11 is a top view of an opposed, coplanar dual strike head pick design of the prior art.

FIG. 12 is a top view of a coplanar tri-head pick design of the prior art.

FIG. 13 is a top view of an alternative tri-head pick design of the prior art.

FIG. 14 is a top view of a down-stroke dual-head, up-stroke single-head pick design of the prior art.

FIG. 15 is a side view of the prior art embodiment of FIG. 14.

FIG. 16 is a bottom view of the prior art embodiment of FIG. 14.

### DESCRIPTION OF THE INVENTION

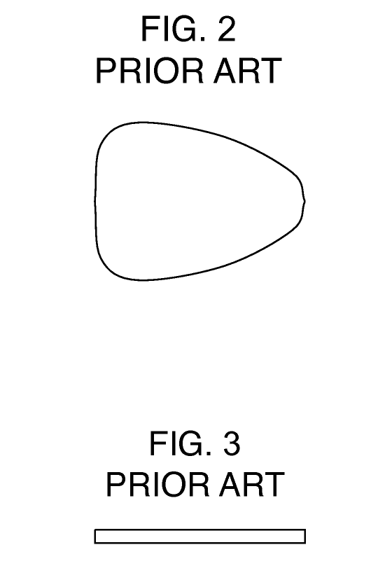

Limitations of six common prior art pick designs, shown in FIGS. 2 and 3, and 10-16, better illustrate certain improvements and features of the present invention. For example, FIGS. 2 and 3 show a common single-strike-head pick of the prior art having a gauge thickness. This prior-art design lacks any augmented gripping means and only enables a musician to attack one string at a time on a given strike. Thus each string is serially hit in a given stroke.

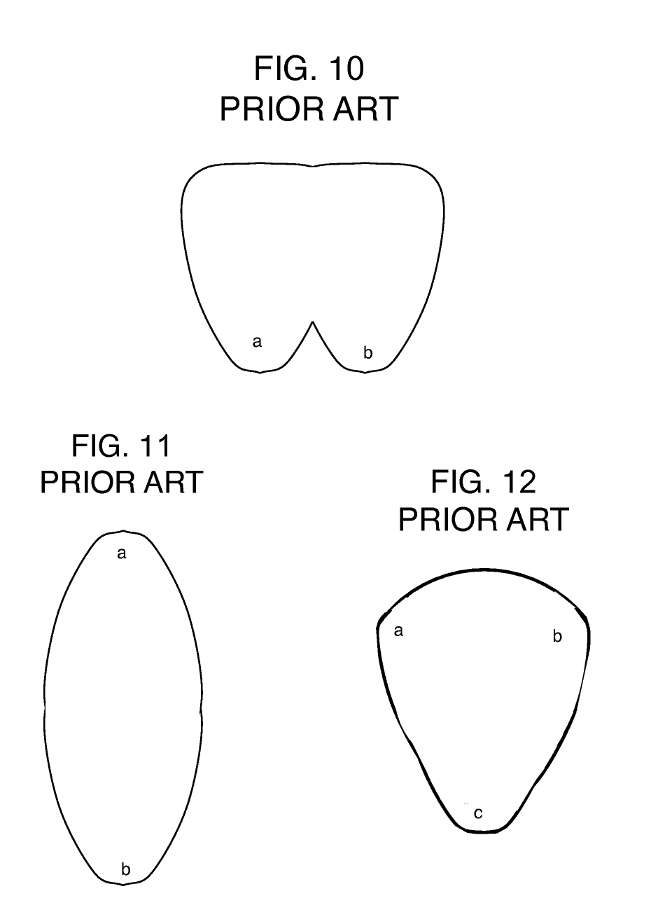

More elaborate prior-art designs include, for example, FIG. 10, which shows a typical coplanar and linear dual-strike head pick. A musician selectively grips this pick to cause both strike head “a” and “b” to hit or attack one string two-times in a downward or upward stroke. Alternatively, the musician grips this prior-art pick in such a way that only one strike head contacts a given string on either the upstroke, down-stroke, or both, when playing a stringed instrument. This prior-art design does not, however, enable the musician to attack two strings simultaneously on a single strike.

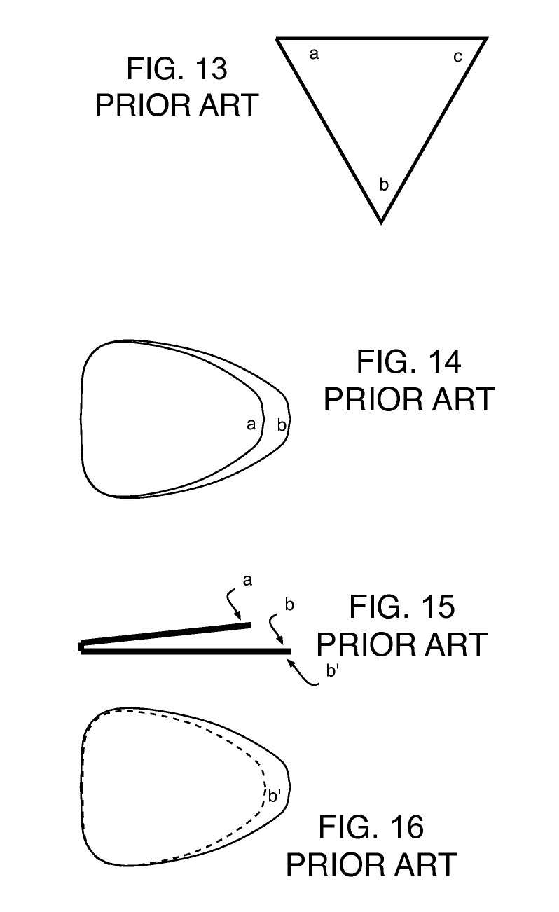

FIG. 11 shows another prior-art design of a coplanar and opposed dual strike-head pick. For example, strike head “a” may be of a relatively thinner cross-section relative to strike head “b”. This allows the musician to alter the sound affected by the striking of the pick against a given string on the instrument; but, only one strike head engages the string on either the upward or downward stroke. Similarly, FIGS. 12 and 13 show a coplanar, tri-head design common in the prior art. Again, each of the designs of FIGS. 11, 12, and 13 can only result in one head striking a given string on a given stroke.

FIGS. 13-16 show a top, side and bottom view, respectively, of a dual strike head pick as taught by the prior art. Specifically, in one direction of travel during a stroke, both the inner strike head “a” and outer strike-head “b” contact a given string on the instrument. However, in the opposite direction of travel the outer strike head, being of a larger size than the inner strike head portion of the main strike body, prevents the inner strike head from contacting the string.

Thus, an uneven sound results consisting of a dual-hit on a down stroke but only a single hit on the upstroke. Finally, each of the prior-art designs shown in FIGS. 2-3 and 10-16 lack any augmented gripping means.

In contrast to the teachings of the prior art, the present invention enables multiple strike heads to simultaneously contact a given string on both the upstroke and the down stroke. Further, the present invention includes other novel features that will be appreciated from the following description. Possible embodiments will now be described with reference to the drawings and those skilled in the art will understand that alternative configurations and combinations of components may be substituted without subtracting from the invention. Also, in some figures certain components are omitted to more clearly illustrate the invention.

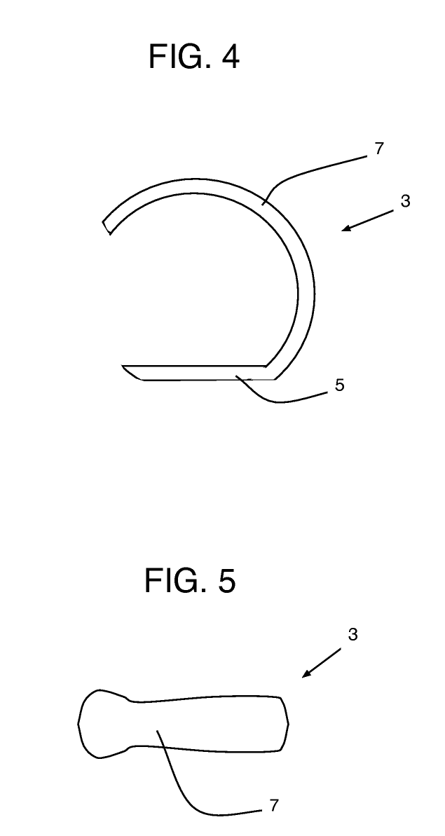

FIGS. 4 and 5 show one possible gripping means 3 according to the present invention. In profile, as shown in FIG. 4, the gripping means comprises a relatively flat base portion 5 adapted to rest on a surface of the main pick body. Contiguously extending from the base portion, a C-shaped or arcuate arm member 7 curves upward and back over the base to create an opening suitably sized for a musician's finger or thumb to pass there-through. The resilient material includes inherent flex enabling varying finger bores to comfortably slide in the opening create by the c-shaped arm 7 and base 5 while simultaneously providing sufficient friction or grip to prevent the pick from sliding off the musician's finger or thumb under most normal circumstances. Although the gripping means 3, as shown in the accompanying figures, illustrates particular combinations of pick bodies, it will be appreciated by those in the art that the gripping means can easily be adapted for use by any type of pick device known.

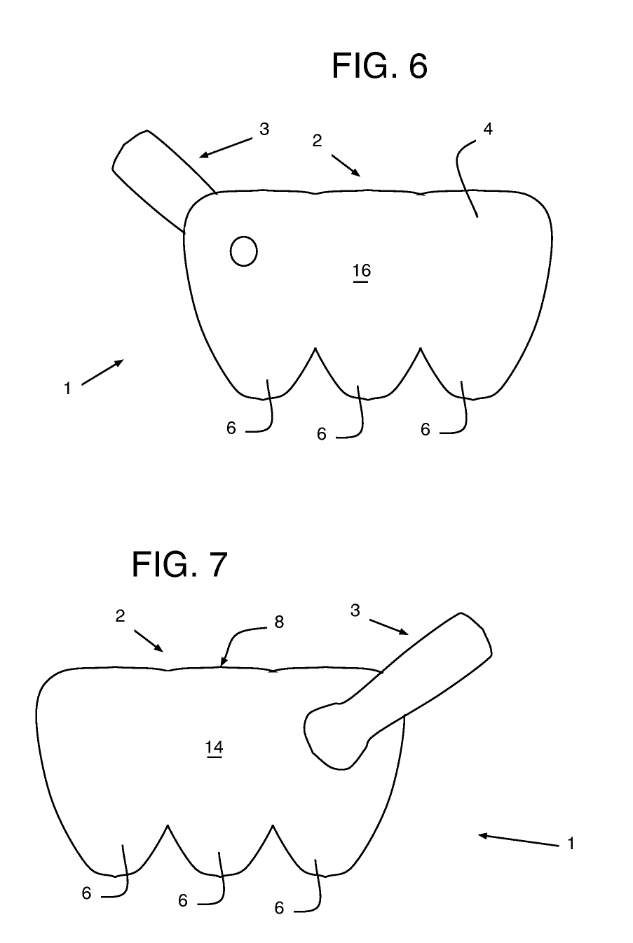

FIGS. 6 and 7 show one embodiment of the present invention 1 comprising an in-line triple strike-head pick having a gripping means 3. FIG. 6 shows a bottom surface 16 of a novel pick 2 and FIG. 7 shows the top surface 14. The contiguous main pick body 4 includes three striking heads 6 and a single tail 8. The gripping means 3 couples to the pick body via an attaching means 9.

As illustrated, this embodiment contemplates a single, common gauge thickness for the each strike head. But, each strike head could be of a different gauge, if desired.

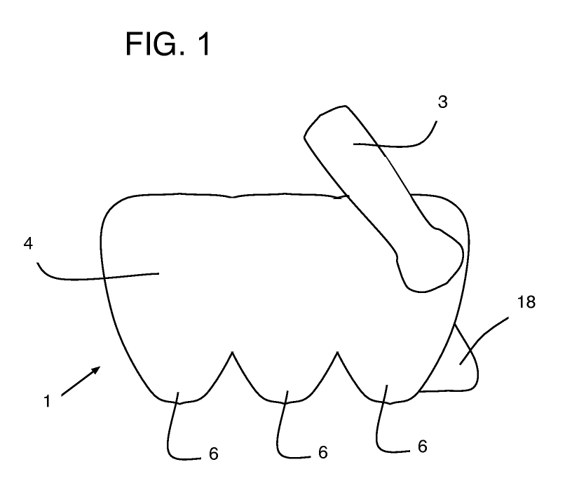

An preferred embodiment, shown in FIG. 1, adds a lead pick 18 to the side of one of the tri-strike-heads 6 of a triple strike-head pick with gripping means 3.

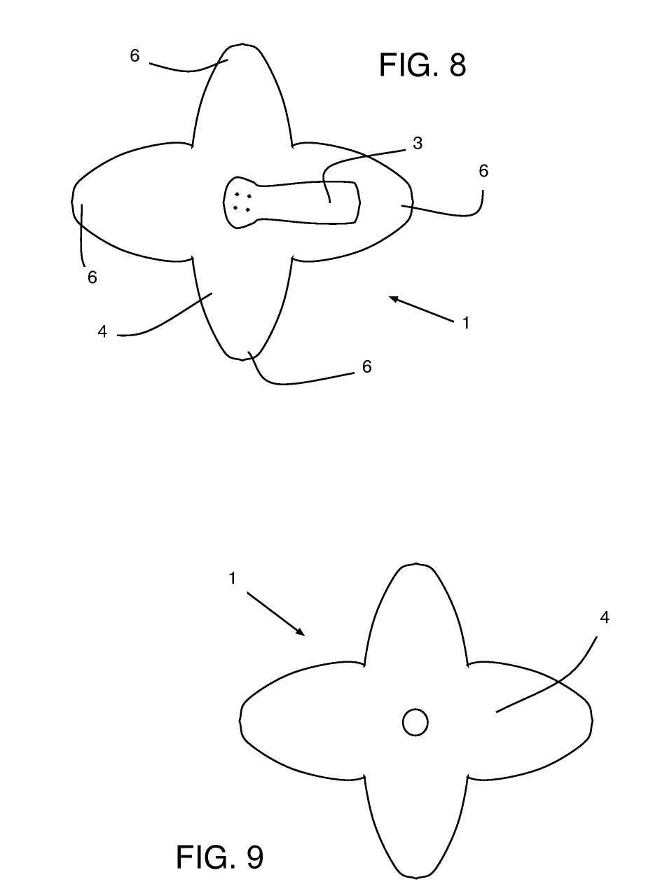

FIGS. 8 and 9 show a quad-head pick body 4 according to another embodiment of the present invention 1. This pick 1 includes four strike heads 6 wherein each strike head lies in the same plane. Each strike head 6 includes a unique gauge thickness, thus enabling the musician to select any one of four different gauges to attack the strings on a given stroke. The rotatably coupled gripping means further enables the musician to solidly hold the pick 1, yet quickly turn or twirl the pick in his hand to ease selection of the appropriate gauge-this enables a rapidly alterable sound quality from a hard edge to a soft edge tone.

The main pick body of the pick device according to the present invention comprises conventional pick material, preferably nylon, but also could be any suitable material known in the art including celluloid, plastic, tortex, delrex, lexan, rubber, felt, tortoiseshell, wood, metal, and stone. The pick device optionally includes a friction-increasing coating to enhance a musician's grip. A suitable shape of the main pick body of the present invention includes shapes as generally known in the prior art including an acute isosceles triangle with two generally equally rounded corners and a third more acutely rounded corner and the present invention contemplates the main pick body or plurality of bodies to include the equilateral pick, the shark's fin pick and the sharp edged pick as well-understood in the art.

The main pick body or plurality of bodies of the present invention includes an overall thickness (or cross section) ranging from about 0.38 mm to about 2.50 mm and may have uniform thickness or a variable thickness. And, as well-understood in the art, the present invention includes a thickness determined by the targeted performance of the device based on its intended use and, therefore, includes relatively “thick” and “thin” cross sections. In many of the embodiments multiple gauged strike heads can be incorporated in a given single pick device. However, a preferred embodiment contemplates uniform pick gauges of about 0.60 mm for each strike head on a given pick device.

In one possible embodiment of the present invention the gripping means is fixably coupled to the main pick body using conventional attaching means (for example attaching means 9 of FIG. 6) including an adhesive suited to bond similar polymers. Other contemplated attaching means include enabling a selective coupling of the gripping means to the main pick body. Such selective coupling means includes a brad or snap connection. Another contemplated attaching means enables the gripping means to have a rotating engagement with the main pick body and such attaching means would include the aforementioned brad or snap as well as a rivet. Other attaching means include Velcro-type hook and loop fastener and magnets. A preferred embodiment of the present invention includes a snap connector as the coupling means between the main pick body and the gripping means. This type of connector may be selectively de-coupled while also allowing for rotating coupling of the gripping means in relation to the main pick body when coupled. One possible resilient material suitable for the gripping means includes a white plastic material similar to the material used on finger and thumb picks manufactured by Jim Dunlop and available at www.jimdunlop.com, such as the material used to make the finger pick model number 9011R.

While the invention has been particularly shown and described with reference to certain embodiments, it will be understood by those skilled in the art that various changes in form and detail may be made without departing from the spirit and scope of the invention.

I claim:

1. A pick device comprising:
a main pick body comprising a plurality of linearly aligned strike heads; and
a gripping means coupled to the main pick body.

2. The pick device of claim 1 wherein the gripping means further includes attaching means adapted to couple to a front surface of the main pick body to enable about 360-degrees of rotation of the gripping means about an axis generally perpendicular to the front surface.

3. The pick device of claim 1 wherein the gripping means further comprises a generally curvilinear clip structure configured to enable a musician to place a finger or thumb there-through to enhance grip of the main pick body and to facilitate stroking the stringed instrument.

4. The pick device of claim 2 wherein the gripping means further comprises an attaching means adapted to selectively couple to the front surface.

5. The pick device of claim 2 wherein the attaching means includes any one of the following: a brad, a snap-structure, or a rivet; and wherein the pick body further is adapted to couple to the attaching means.

6. The pick device of claim 1 wherein the main pick body comprises a first resilient material and wherein the gripping means comprises a second resilient material.

7. The pick device of claim 1 wherein the pick device comprises a resilient material and each linearly aligned strike head includes an associated thickness.

8. The pick device of claim 7 wherein a first strike head of the plurality of linearly aligned strike heads includes a first thickness and a second strike head includes a second thickness.

9. A pick device comprising:
a main pick body comprising four strike heads, each strike head arranged generally in a common plane and whereby at least one strike head is arranged about 90-degrees from a second strike head.

10. The pick device of claim 9 further comprising a gripping means coupled to the main pick body.

11. The pick device of claim 9 further comprising a gripping means fixably coupled to the main pick body.

12. The pick device of claim 10 wherein the gripping means further includes attaching means adapted to couple to a front surface of the main pick body to enable about 360-degrees of rotation of the gripping means about an axis generally perpendicular to the front surface.

13. The pick device of claim 10 wherein the gripping means further comprises a generally curvilinear clip structure configured to enable a musician to place a finger or thumb therethrough to enhance grip of the main pick body and to facilitate stroking the stringed instrument.

14. The pick device of claim 10 wherein the gripping means further comprises an attaching means adapted to selectively couple to the front surface.

15. The pick device of claim 14 wherein the attaching means includes any one of the following: a brad, a snap-structure, or a rivet; and wherein the pick body further is adapted to couple to the attaching means.

16. The pick device of claim 10 wherein the main pick body comprises a first resilient material and wherein the gripping means comprises a second resilient material.

17. The pick device of claim 9 wherein the pick device comprises a resilient material and each strike head includes an associated thickness.

18. The pick device of claim 9 wherein a first strike head includes a first thickness and a second strike head includes a second thickness.

19. A pick device for a stringed instrument comprising:
a pick body comprising a plurality of strike heads; and
a gripping means coupled to the pick body, the gripping means comprises a generally curvilinear clip structure configured to enable a musician to place a finger or thumb there-through to enhance grip of the main pick body and to facilitate stroking the stringed instrument.

20. The pick device of claim 19 further comprising an attaching adapted to couple the gripping means to the pick body to enable about 360-degrees of rotation of the gripping means about an axis.
